(19) United States
(12) Patent Application Publication
(10) Pub. No.: US 2024/0120625 A1
(43) Pub. Date: Apr. 11, 2024

(54) CYLINDRICAL BATTERY CELL, BATTERY AND METHOD FOR FORMING CYLINDRICAL BATTERY CELL

(71) Applicant: GOTION, INC., Fremont, CA (US)

(72) Inventors: Tobias SCHMIEG, Hefei City, Anhui (CN); Chen LI, Hefei City, Anhui (CN); Qian CHENG, Hefei City, Anhui (CN); Bingjie SHEN, Hefei City, Anhui (CN)

(21) Appl. No.: 18/276,458

(22) PCT Filed: Feb. 10, 2021
(86) PCT No.: PCT/CN2021/076580

§ 371 Date: Aug. 9, 2023

(51) Int. Cl. H01M 50/538; H01M 10/04; H01M 50/107; H01M 50/152; H01M 50/474; H01M 50/477; H01M 50/534; H01M 50/627

(52) U.S. Cl. CPC H01M 50/538; H01M 10/0431; H01M 50/107; H01M 50/152; H01M 50/474; H01M 50/477; H01M 50/534; H01M 50/627

(57) ABSTRACT

A cylindrical battery cell, a battery and a method for preparing a cylindrical battery cell are provided. The cylindrical battery cell includes a cylindrical can; a jellyroll structure which is arranged inside the cylindrical can; a cathode disk which is arranged on a first side of the cylindrical can in an axial direction; an anode ring which is arranged on the first side of the cylindrical can in the axial direction; and an insulation element which is arranged between the cathode disk and the anode ring. Therefore, the current path in the cylindrical battery cell is shortened, and additional heat-loss and electrical resistance are decreased, furthermore, the wall thickness of the cylindrical can does not need to be increased, which will improve filling ratio and efficiency of the cylindrical battery cell.

### CROSS-REFERENCE TO RELATED APPLICATION(S)

The present disclosure is a national stage application of International Patent Application No. PCT/CN2021/076580, which is filed on Feb. 10, 2021.

### TECHNICAL FIELD

Embodiments of the present disclosure generally relate to the field of power control circuits, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, formfactors of the cylindrical battery cell may be from 21700 (diameter is 21 mm and height is 70 mm) to 50120 (diameter is 50 mm and height is 120 mm), and the cylindrical battery may include a jellyroll structure.

In general, the cylindrical battery cell exceeding 21700 formfactor need to have a special tab-design in order to ensure sufficient ampacity from foils of the jellyroll structure to a cylindrical can or a terminal. Furthermore, cylindrical battery cells are most commonly oriented vertical, usually the terminal is used as a plus (+) electrode and the cylindrical can is used as a minus (−) electrode.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that in some existing schemes, a current has to travel from a bottom of the jellyroll structure to a top of the jellyroll structure via the cylindrical can (cell housing). The cylindrical battery cell in terms of capacity is bigger, the resulting current is higher. This is resulting in additional heat source and electrical resistance creating heat-loss and also inefficiency.

In order to compensate for heat-loss (especially during peak performance or fast charging), a wall thickness of the cylindrical can has to be increased. This will lead to significantly worse filling ratio and loss in space, where usually the space for electrodes and jellyroll structure could be utilized. This also means cell design constantly has to be changed and updated based on rated capacity in order to have perfect balance of energy, cost and electrical resistance.

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to decrease (or shorten) a current path in a cylindrical battery cell, decrease additional heat-loss and electrical resistance and improve efficiency of the cylindrical battery cell with a simple structure.

In a first aspect, a cylindrical battery cell is provided. The cylindrical battery cell includes:
a cylindrical can;
a jellyroll structure which is arranged inside the cylindrical can, wherein the jellyroll structure includes a rolled anode foil, a rolled cathode foil and a rolled separator between the rolled anode foil and the rolled cathode foil;
a cathode disk which is arranged on a first side of the cylindrical can in an axial direction, and the cathode disk is electronically connected to the cathode foil of the jellyroll structure;
an anode ring which is arranged on the first side of the cylindrical can in the axial direction, and the anode ring is electronically connected to the anode foil of the jellyroll structure; and
an insulation element which is arranged between the cathode disk and the anode ring.

In some embodiments, the cylindrical battery cell further includes: a terminal which is arranged on the first side of the cylindrical can and is electronically connected to the cathode disk.

In some embodiments, the cylindrical battery cell further includes: a cap plate which is arranged on the first side of the cylindrical can, wherein the cap plate is arranged on the cathode disk and the anode ring, and the cap plate have a hole in which the terminal is arranged.

In some embodiments, the anode ring is arranged outside of the cathode disk in a radial direction.

In some embodiments, the anode ring further includes a flat ring in the radial direction and a wall portion in the axial direction, an insulation ring as the insulation element is arranged inside the wall portion and on the flat ring, and the cathode disk is arranged inside of the insulation ring in the radial direction.

In some embodiments, the cathode disk is an aluminum disk used as a positive electrode, and the anode ring is a copper ring used as a negative electrode.

In some embodiments, the anode foil comprises a first rectangular plate and a first additional portion protruding from the first rectangular plate in the axial direction, before the anode foil is rolled.

In some embodiments, the first additional portion is outside of the anode foil and on the first side of the cylindrical can, after the anode foil is rolled, and the first addition portion is electronically connected to the anode ring.

In some embodiments, the cathode foil comprises a second rectangular plate and a second additional portion protruding from the second rectangular plate in the axial direction, before the cathode foil is rolled.

In some embodiments, the second additional portion is inside of the cathode foil and on the first side of the cylindrical can, after the cathode foil is rolled, and the second addition portion is electronically connected to the cathode disk.

In some embodiments, a plurality of rings of the rolled anode foil on a second side of the cylindrical can are electronically connected via a conductive element.

In some embodiments, the cylindrical battery cell further includes: an injection hole which is arranged in a stop plate on a second side of the cylindrical can.

In some embodiments, the cylindrical battery cell further includes: an injection hole which is arranged in a cap plate on the first side of the cylindrical can.

In a second aspect, a method for forming cylindrical battery cell is provided. The method comprises:
forming a cylindrical can;
forming a jellyroll structure which is arranged inside the cylindrical can, wherein the jellyroll structure comprises a rolled anode foil, a rolled cathode foil and a rolled separator between the rolled anode foil and the rolled cathode foil;
forming a cathode disk which is arranged on a first side of the cylindrical can in an axial direction, and the cathode disk is electronically connected to the cathode foil of the jellyroll structure;
forming an anode ring which is arranged on the first side of the cylindrical can in the axial direction, and the anode ring is electronically connected to the anode foil of the jellyroll structure; and
forming an insulation element which is arranged between the cathode disk and the anode ring.

In some embodiments, the method further includes: forming a terminal which is arranged on the first side of the cylindrical can and is electronically connected to the cathode disk.

In some embodiments, the method further includes: forming a cap plate which is arranged on the first side of the cylindrical can, wherein the cap plate is arranged on the cathode disk and the anode ring, and the cap plate have a hole in which the terminal is arranged.

In a third aspect, a battery is provided, the battery includes a plurality of the cylindrical battery cell according to the first aspect of the embodiments.

According to various embodiments of the present disclosure, the current travels inside the cylindrical can and the current path in the cylindrical battery cell is shortened, therefore additional heat-loss and electrical resistance are decreased, furthermore, a wall thickness of the cylindrical can needn't to be increased, this will improve filling ratio and efficiency of the cylindrical battery cell.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a current path in a traditional cylindrical battery cell;

FIG. 2 is a diagram which shows a cylindrical battery cell in accordance with an embodiment of the present disclosure;

FIG. 3 is another diagram which shows a section view of the cylindrical battery cell in accordance with an embodiment of the present disclosure;

FIG. 4 is another diagram which shows an explosion view of the cylindrical battery cell in accordance with an embodiment of the present disclosure;

FIG. 5 is a diagram which shows the anode ring, the cathode disk and the insulation element in accordance with an embodiment of the present disclosure;

FIG. 6 is a diagram which shows a section view of the jellyroll structure 202 in accordance with an embodiment of the present disclosure;

FIG. 7 is a diagram which shows an anode foil of the jellyroll structure in accordance with an embodiment of the present disclosure;

FIG. 8 is a diagram which shows a cathode foil of the jellyroll structure in accordance with an embodiment of the present disclosure;

FIG. 9 is a diagram which shows a cylindrical battery cell in accordance with an embodiment of the present disclosure;

FIG. 10 is another diagram which shows a section view of the cylindrical battery cell in accordance with an embodiment of the present disclosure;

FIG. 11 is another diagram which shows an explosion view of the cylindrical battery cell in accordance with an embodiment of the present disclosure;

FIG. 12 is a diagram which shows a method for forming cylindrical battery cell in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

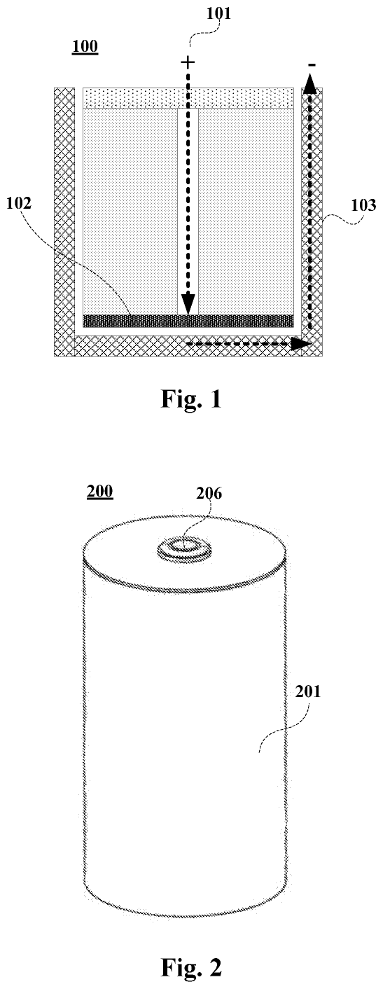

FIG. 1 is a diagram which shows a current path in a traditional cylindrical battery cell. As shown in FIG. 1, a terminal 101 is used as a plus (+) electrode (or positive electrode) and a current collector (such as a copper plate) 102 is arranged at the bottom of the cylindrical battery cell 100. The current collector 102 is welded to the cylindrical can 103 and the cylindrical can 103 is used as a minus (−) electrode (or negative electrode).

As shown in FIG. 1, the current (shown by the arrow) has to travel from the bottom of the cylindrical battery cell 100 to the top of the cylindrical battery cell 100 via the cylindrical can 103. This is resulting in additional heat source and electrical resistance creating heat-loss and also inefficiency. Furthermore, a wall thickness of the cylindrical can 103 has to be increased. This will lead to significantly worse filling ratio and loss in space.

In order to solve at least part of the above problems, a cylindrical battery cell, a battery and a method for forming cylindrical battery cell are provided in the present disclosure.

### A First Aspect of Embodiments

A cylindrical battery cell is provided in the embodiments.

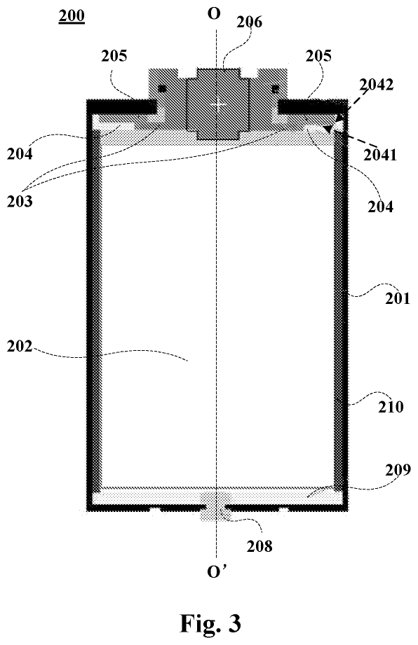

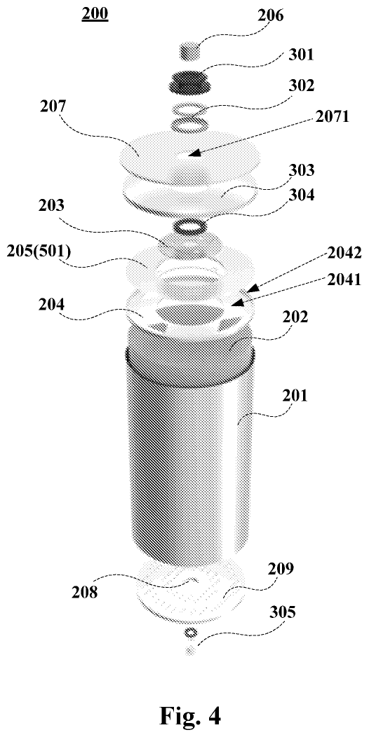

FIG. 2 is a diagram which shows a cylindrical battery cell 200 in accordance with an embodiment of the present disclosure. FIG. 3 is another diagram which shows a section view of the cylindrical battery cell 200 in accordance with an embodiment of the present disclosure. FIG. 4 is another diagram which shows an explosion view of the cylindrical battery cell 200 in accordance with an embodiment of the present disclosure.

As shown in FIG. 2 to FIG. 4, a cylindrical battery cell 200 includes: a cylindrical can 201, a jellyroll structure 202, a cathode disk 203, an anode ring 204 and an insulation element 205.

In some embodiments, the jellyroll structure 202 is arranged inside the cylindrical can 201, wherein the jellyroll structure 202 includes a rolled anode foil, a rolled cathode foil and a rolled separator between the rolled anode foil and the rolled cathode foil. As shown in FIG. 3, an insulation film 210 may be arranged between the jellyroll structure 202 and the cylindrical can 201.

As shown in FIG. 3 and FIG. 4, the cathode disk 203 is arranged on a first side (top side shown in FIG. 3 and FIG. 4) of the cylindrical can 201 in an axial direction (see axial OO′ as shown in FIG. 3), and the cathode disk 203 is electronically connected to the cathode foil of the jellyroll structure 202.

As shown in FIG. 3 and FIG. 4, the anode ring 204 is arranged on the first side of the cylindrical can 201 in the axial direction, and the anode ring 204 is electronically connected to the anode foil of the jellyroll structure 202; and the insulation element 205 is arranged between the cathode disk 203 and the anode ring 204.

It should be appreciated that some components or elements are illustrated only as examples in FIG. 2 to FIG. 4. However, it is not limited thereto, for example, connections or positions of the components or elements may be adjusted, and/or, some components or elements may be omitted.

Therefore, the cathode disk 203 is used for cathode current collection and the anode ring 204 is used for anode current collection, while both the cathode disk 203 and the anode ring 204 are arranged on the top side of the cylindrical can 201. The current path in the cylindrical battery cell 200 is decreased, therefore additional heat-loss and electrical resistance are decreased.

Furthermore, the current will travel inside the jellyroll structure 202 and may be no longer travel via the cylindrical can 201. Therefore, a wall thickness of the cylindrical can 201 not need to be increased, this will improve filling ratio, and improve efficiency of the cylindrical battery cell.

In some embodiments, as shown in FIG. 3 and FIG. 4, the cylindrical battery cell 200 further includes: a terminal 206 which is arranged on the first side of the cylindrical can 201 and is electronically connected to the cathode disk 203.

For example, the terminal 206 is used as a positive terminal. In some embodiments, the anode ring 204 may also be electronically connected to the cylindrical can 201 and the cylindrical can 201 is used as a negative terminal, and it is not limited thereto. Therefore, the cylindrical battery cell can be designed with a simple structure.

In some embodiments, as shown in FIG. 3 and FIG. 4, the cylindrical battery cell 200 further includes: a cap plate 207 which is arranged on the first side of the cylindrical can 201, wherein the cap plate 207 is arranged on the cathode disk 203 and the anode ring 204, and the cap plate 207 have a hole 2071 in which the terminal 206 is arranged.

In some embodiments, the anode ring 204 is arranged outside of the cathode disk 203 in a radial direction.

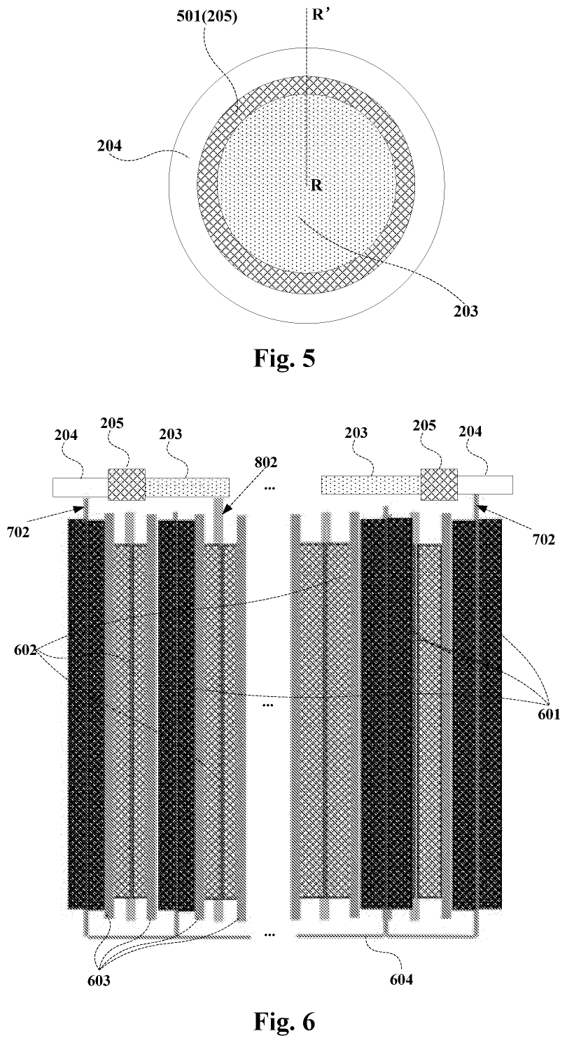

FIG. 5 is a diagram which shows the anode ring, the cathode disk and the insulation element in accordance with an embodiment of the present disclosure. As shown in FIG. 5, the anode ring 204 is arranged outside of the cathode disk 203 in a radial direction (see radial direction RR′ shown in FIG. 5) and an insulation element 205 is arranged between the anode ring 204 and the cathode disk 203. Therefore, the anode ring 204 and the cathode disk 203 are arranged on the same side with a simple structure.

In some embodiments, as shown in FIG. 3 and FIG. 4, the anode ring 204 further includes a flat ring 2041 in the radial direction and a wall portion 2042 in the axial direction, an insulation ring 501 as the insulation element 205 is arranged inside the wall portion 2042 and on the flat ring 2041, and the cathode disk 203 is arranged inside of the insulation ring 501 in the radial direction. Therefore, the anode ring 204 and the cathode disk 203 are arranged with a simple structure.

In some embodiments, the cathode disk 203 is an aluminum disk used as a positive electrode, and the anode ring 204 is a copper ring used as a negative electrode. However, it is not limited thereto, for example, other material may be adopted for the cathode disk 203 and the anode ring 204.

For example, the material of the cathode disk 203 is mainly Al and the material of the anode ring 204 is Cu. The Al disk is used as a positive electrode and the Cu ring is used as a negative electrode. However, it is not limited thereto.

FIG. 6 is a diagram which shows a section view of the jellyroll structure 202 in accordance with an embodiment of the present disclosure. As shown in FIG. 6, the jellyroll structure 202 includes a rolled anode foil 601, a rolled cathode foil 602 and a rolled separator 603 between the rolled anode foil 601 and the rolled cathode foil 602.

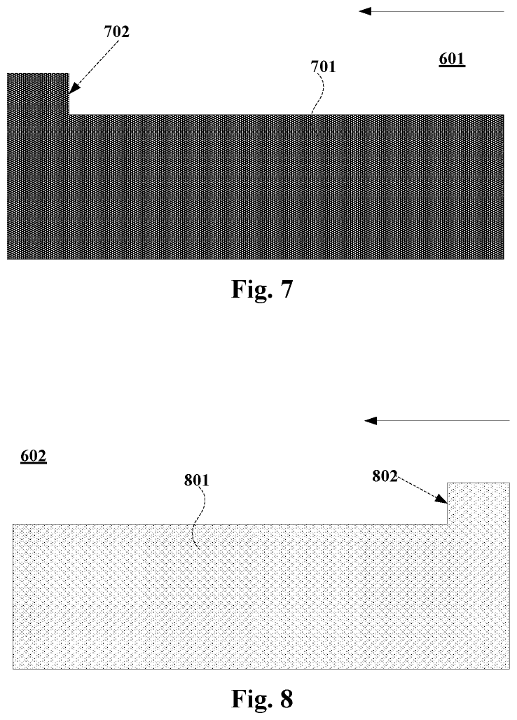

FIG. 7 is a diagram which shows an anode foil of the jellyroll structure in accordance with an embodiment of the present disclosure. As shown in FIG. 7, the anode foil 601 includes a first rectangular plate 701 and a first additional portion (tab) 702 protruding from the first rectangular plate 701 in the axial direction, before the anode foil 601 is rolled.

In a manufacture process, the anode foil 601 can be rolled form one side to other side (see an arrow shown in the FIG. 7). As shown in FIG. 6, the first additional portion 702 is outside of the anode foil 601 and on the first side of the cylindrical can 201, after the anode foil 601 is rolled, and the first addition portion 702 is electronically connected to the anode ring 204.

Therefore, the anode ring 204 can be electronically connected to the first addition portion (tab) 702 with a simple structure, the space inside the cylindrical can 201 could be further saved.

FIG. 8 is a diagram which shows a cathode foil of the jellyroll structure in accordance with an embodiment of the present disclosure. As shown in FIG. 8, the cathode foil 602 includes a second rectangular plate 801 and a second additional portion (tab) 802 protruding from the second rectangular plate 801 in the axial direction, before the cathode foil 602 is rolled.

In a manufacture process, the cathode foil 602 can be rolled form one side to other side (see an arrow shown in the FIG. 8). As shown in FIG. 6, the second additional portion 802 is inside of the cathode foil 602 and on the first side of the cylindrical can 201, after the cathode foil 602 is rolled, and the second addition portion 802 is electronically connected to the cathode disk 203.

Therefore, the cathode disk 203 can be electronically connected to the second addition portion (tab) 802 with a simple structure, the space inside the cylindrical can 201 could be further saved.

As shown in FIG. 6, a plurality of rings of the rolled anode foil 601 on a second side (bottom side) of the cylindrical can 201 are electronically connected via a conductive element 604. For example, the plurality of rings of the rolled anode foil 601 are connected by a copper wire.

Therefore, the anode foil may still electrically connect through a flattening process on the bottom of the jellyroll structure. This will ensure a very even and homogenous current distribution on the anode side to minimize negative impact towards accelerated aging.

In some embodiments, as shown in FIG. 3 and FIG. 4, the cylindrical battery cell 200 may further include: an injection hole 208 which is arranged in a stop plate 209 on a second side of the cylindrical can 201. This structure may be called P1 structure.

In some embodiments, cylindrical battery cell may further include: an injection hole which is arranged in a cap plate on the first side of the cylindrical can.

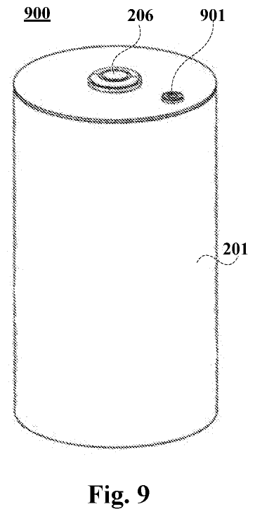

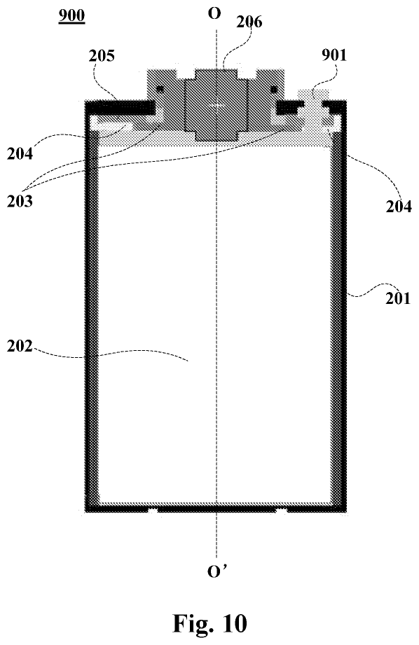

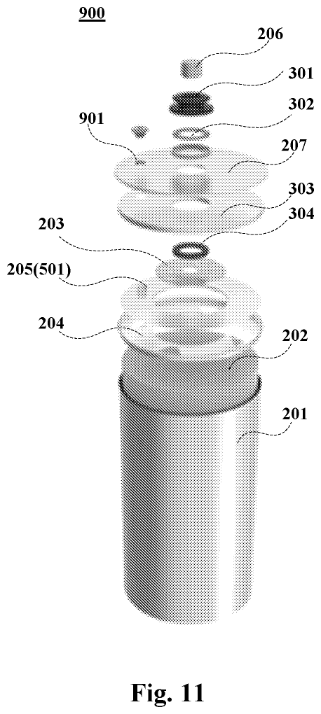

FIG. 9 is a diagram which shows a cylindrical battery cell 900 in accordance with an embodiment of the present disclosure. FIG. 10 is another diagram which shows a section view of the cylindrical battery cell 900 in accordance with an embodiment of the present disclosure. FIG. 11 is another diagram which shows an explosion view of the cylindrical battery cell 900 in accordance with an embodiment of the present disclosure.

As shown in FIG. 9 to FIG. 11, the cylindrical battery cell 900 may further include: an injection hole 901 which is arranged in a cap plate 207 on the first side of the cylindrical can 201. This structure may be called P2 structure.

It should be appreciated that some components or elements are illustrated only as examples in FIG. 9 to FIG. 11. However, it is not limited thereto, for example, connections or positions of the components or elements may be adjusted, and/or, some components or elements may be omitted.

Furthermore, there are some other elements in some embodiments, such as a positive insulation 301, a sealing 302, an insulation ring 303, a seal 304 and a seal nail 305 in FIG. 4, or such as a positive insulation 301, a sealing 302, an insulation ring 303, a seal 304 in FIG. 11, and it is not limited thereto.

It is to be understood that, the above examples or embodiments are discussed for illustration, rather than limitation. Those skilled in the art would appreciate that there may be many other embodiments or examples within the scope of the present disclosure.

It can be seen from the above embodiments, the current travels inside the cylindrical can and the current path in the cylindrical battery cell is shortened, therefore additional heat-loss and electrical resistance are decreased, furthermore, a wall thickness of the cylindrical can needn't to be increased, this will improve filling ratio and efficiency of the cylindrical battery cell.

### A Second Aspect of Embodiments

A method for forming cylindrical battery cell is provided in the embodiments. The corresponding devices 200 or 900 are illustrated in the first aspect of embodiments, and the same contents as those in the first aspect of embodiments are omitted.

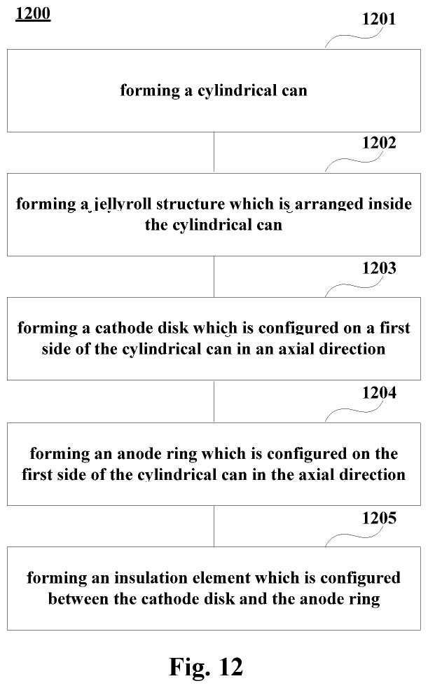

FIG. 12 is a diagram which shows a method for forming cylindrical battery cell in accordance with an embodiment of the present disclosure. As shown in FIG. 12, a method 1200 for forming cylindrical battery cell includes:
1201, forming a cylindrical can;
1202, forming a jellyroll structure which is arranged inside the cylindrical can, wherein the jellyroll structure includes a rolled anode foil, a rolled cathode foil and a rolled separator between the rolled anode foil and the rolled cathode foil;
1203, forming a cathode disk which is arranged on a first side of the cylindrical can in an axial direction, and the cathode disk is electronically connected to the cathode foil of the jellyroll structure;
1204, forming an anode ring which is arranged on the first side of the cylindrical can in the axial direction, and the anode ring is electronically connected to the anode foil of the jellyroll structure; and
1205, forming an insulation element which is arranged between the cathode disk and the anode ring.

It should be appreciated that FIG. 12 is only an example of the disclosure, but it is not limited thereto. For example, the order of operations at blocks or steps may be adjusted, and/or, some blocks or steps may be omitted. Moreover, some blocks or steps not shown in FIG. 12 may be added.

In some embodiments, the method further includes: forming a terminal which is arranged on the first side of the cylindrical can and is electronically connected to the cathode disk.

In some embodiments, the method further includes: forming a cap plate which is arranged on the first side of the cylindrical can, wherein the cap plate is arranged on the cathode disk and the anode ring, and the cap plate have a hole in which the terminal is arranged.

In some embodiments, the anode foil includes a first rectangular plate and a first additional portion protruding from the first rectangular plate in the axial direction, before the anode foil is rolled; the first additional portion is outside of the anode foil and on the first side of the cylindrical can, after the anode foil is rolled, and the first addition portion is electronically connected to the anode ring.

In some embodiments, the cathode foil includes a second rectangular plate and a second additional portion protruding from the second rectangular plate in the axial direction, before the cathode foil is rolled; the second additional portion inside of the cathode foil and on the first side of the cylindrical can, after the cathode foil is rolled, and the second addition portion is electronically connected to the cathode disk.

In some embodiments, the anode ring is arranged outside of the cathode disk in a radial direction; and a plurality of rings of the rolled anode foil on a second side of the cylindrical can are electronically connected via a conductive element.

It can be seen from the above embodiments, the current travels inside the cylindrical can and the current path in a cylindrical battery cell is shortened, therefore additional heat-loss and electrical resistance are decreased, furthermore, a wall thickness of the cylindrical can needn't to be increased, this will improve filling ratio and efficiency of the cylindrical battery cell.

### A Third Aspect of Embodiments

A battery is provided in the embodiments. The corresponding devices 200 or 900 and the method 1200 are illustrated in the first and second aspects of embodiments, and the same contents as those in the first and second aspects of embodiments are omitted.

In some embodiments, the battery includes a plurality of the cylindrical battery cell according to the first aspects of embodiments.

In some embodiments, a current path is dramatically shortened from an anode side to a cylindrical can and/or a busbar connector. It also enables a significant increase in jellyroll height which will lead to more energy. Also, a height of the cylindrical battery cell and a resulting capacity could easily be scaled for customer needs and application without significant changes on the cell design.

For example, compared to traditional cylindrical battery cell such as 4680 cells, some estimates of the cylindrical battery cell in the present application include: 5-6% energy (due to better filling ratio) is added with the same chemistry condition; 6-8% heat loss on system level is decreased as there is no current via cell-can; there are 5-6% less weight and less cost.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, comprising:
a cylindrical can;
a jellyroll structure which is arranged inside the cylindrical can, wherein the jellyroll structure comprises a rolled anode foil, a rolled cathode foil and a rolled separator between the rolled anode foil and the rolled cathode foil;
a cathode disk which is arranged on a first side of the cylindrical can in an axial direction, and the cathode disk is electronically connected to the cathode foil of the jellyroll structure;
an anode ring which is arranged on the first side of the cylindrical can in the axial direction, and the anode ring is electronically connected to the anode foil of the jellyroll structure; and
an insulation element which is arranged between the cathode disk and the anode ring.

2. The cylindrical battery cell according to claim 1, wherein the cylindrical battery cell further comprises:
a terminal which is arranged on the first side of the cylindrical can and is electronically connected to the cathode disk.

3. The cylindrical battery cell according to claim 1, wherein the cylindrical battery cell further comprises:
a cap plate which is arranged on the first side of the cylindrical can, wherein the cap plate is arranged on the cathode disk and the anode ring, and the cap plate have a hole in which the terminal is arranged.

4. The cylindrical battery cell according to claim 1, wherein the anode ring is arranged outside of the cathode disk in a radial direction.

5. The cylindrical battery cell according to claim 4, wherein the anode ring further comprises a flat ring in the radial direction and a wall portion in the axial direction, an insulation ring as the insulation element is arranged inside the wall portion and on the flat ring, and the cathode disk is arranged inside of the insulation ring in the radial direction.

6. The cylindrical battery cell according to claim 1, wherein the cathode disk is an aluminum disk used as a positive electrode, and the anode ring is a copper ring used as a negative electrode.

7. The cylindrical battery cell according to claim 1, wherein the anode foil comprises a first rectangular plate and a first additional portion protruding from the first rectangular plate in the axial direction, before the anode foil is rolled.

8. The cylindrical battery cell according to claim 7, wherein the first additional portion is outside of the anode foil and on the first side of the cylindrical can, after the anode foil is rolled,
and the first addition portion is electronically connected to the anode ring.

9. The cylindrical battery cell according to claim 1, wherein the cathode foil comprises a second rectangular plate and a second additional portion protruding from the second rectangular plate in the axial direction, before the cathode foil is rolled.

10. The cylindrical battery cell according to claim 9, wherein the second additional portion is inside of the cathode foil and on the first side of the cylindrical can, after the cathode foil is rolled,
and the second addition portion is electronically connected to the cathode disk.

11. The cylindrical battery cell according to claim 1, wherein a plurality of rings of the rolled anode foil on a second side of the cylindrical can are electronically connected via a conductive element.

12. The cylindrical battery cell according to claim 1, wherein cylindrical battery cell further comprises:
an injection hole which is arranged in a stop plate on a second side of the cylindrical can.

13. The cylindrical battery cell according to claim 1, wherein cylindrical battery cell further comprises:
an injection hole which is arranged in a cap plate on the first side of the cylindrical can.

14. A method for forming cylindrical battery cell, comprising:
forming a cylindrical can;
forming a jellyroll structure which is arranged inside the cylindrical can, wherein the jellyroll structure comprises a rolled anode foil, a rolled cathode foil and a rolled separator between the rolled anode foil and the rolled cathode foil;
forming a cathode disk which is arranged on a first side of the cylindrical can in an axial direction, and the cathode disk is electronically connected to the cathode foil of the jellyroll structure;
forming an anode ring which is arranged on the first side of the cylindrical can in the axial direction, and the anode ring is electronically connected to the anode foil of the jellyroll structure; and
forming an insulation element which is arranged between the cathode disk and the anode ring.

15. The method according to claim 14, wherein the method further comprises:
forming a terminal which is arranged on the first side of the cylindrical can and is electronically connected to the cathode disk.

16. The method according to claim 14, wherein the method further comprises:
forming a cap plate which is arranged on the first side of the cylindrical can, wherein the cap plate is arranged on the cathode disk and the anode ring, and the cap plate have a hole in which the terminal is arranged.

17. The method according to claim 14, wherein the anode foil comprises a first rectangular plate and a first additional portion protruding from the first rectangular plate in the axial direction, before the anode foil is rolled;
the first additional portion is outside of the anode foil and on the first side of the cylindrical can, after the anode foil is rolled,
and the first addition portion is electronically connected to the anode ring.

18. The method according to claim 14, wherein the cathode foil comprises a second rectangular plate and a second additional portion protruding from the second rectangular plate in the axial direction, before the cathode foil is rolled;
the second additional portion is inside of the cathode foil and on the first side of the cylindrical can, after the cathode foil is rolled,
and the second addition portion is electronically connected to the cathode disk.

19. The method according to claim 14, wherein the anode ring is arranged outside of the cathode disk in a radial direction; and a plurality of rings of the rolled anode foil on a second side of the cylindrical can are electronically connected via a conductive element.

20. A battery, comprising a plurality of the cylindrical battery cell according to claim 1.
